(19) United States
(12) Patent Application Publication
(10) Pub. No.: US 2026/0105472 A1
(43) Pub. Date: Apr. 16, 2026

(54) PREDICTION DEVICE, LEARNING DEVICE, PREDICTION METHOD, LEARNING METHOD AND COMPUTER PROGRAM

(71) Applicant: NTT, INC., Tokyo (JP)

(72) Inventors: Noriko YOKOYAMA, Tokyo (JP); Jun ITO, Tokyo (JP); Takahiro HATA, Tokyo (JP); Masato KAMIYA, Tokyo (JP)

(73) Assignee: NTT, INC., Tokyo (JP)

(21) Appl. No.: 19/128,479

(22) PCT Filed: Nov. 14, 2022
(86) PCT No.: PCT/JP2022/042285

§ 371 Date: May 8, 2025

(51) Int. Cl. G06Q 30/0202

(52) U.S. Cl. CPC G06Q 30/0202

(57) ABSTRACT

A prediction device includes: a store visit number prediction unit that acquires data regarding the number of past visits to a store, inputs the data to a trained store visit number prediction model, and predicts the number of visits to a store on a prediction target day by using an output from the store visit number prediction model, a rate prediction unit that acquires data regarding the number of past visits to a store, a past sales volume, a menu feature, and a popular product to predict popularity of each product on the prediction target day, inputs the popularity to a trained sales rate prediction model, and predicts a sales rate of each product by using an output from the sales rate prediction model; and a sales volume prediction unit that predicts a sales volume of each product on the prediction target day by using the number of visits to a store predicted by the store visit number prediction unit and the sales rate of each product predicted by the rate prediction unit.

### TECHNICAL FIELD

The disclosed technology relates to a prediction device, a learning device, a prediction method, a learning method, and a computer program.

### BACKGROUND ART

For example, as in Non Patent Literature 1, as a conventional sales volume prediction technology, there is a technology of predicting a sales volume by combining pieces of external data such as point of sales (POS) data, weather data, and event data.

### CITATION LIST

### Non Patent Literature

Non Patent Literature 1: Food Sales Prediction: “If Only It Knew What We Know”

### SUMMARY OF INVENTION

### Technical Problem

In a case where a daily changing category exists in products to be provided, such as dishes to be provided at a restaurant, the sales volume of each category greatly varies depending on a menu or a combination of menus of the day. In addition, since the number of kinds or a combination of menus including fluctuation in menu names is enormous, it is difficult to perform prediction in consideration of the kinds or a combination of menus in the related art. In a case where there is a difference between the prediction result and the actual sales volume, the cooked dish is discarded, and a so-called food loss problem occurs.

The disclosed technology has been made in view of the above points, and an object thereof is to provide a prediction device, a learning device, a prediction method, a learning method, and a computer program that are capable of performing prediction in consideration of the kind or a combination of products even in a case where a daily changing category exists in products to be provided.

### Solution to Problem

According to a first aspect of the present disclosure, there is provided a prediction device including: a store visit number prediction unit that acquires data regarding the number of past visits to a store, inputs the data to a trained store visit number prediction model, and predicts the number of visits to a store on a prediction target day by using an output from the store visit number prediction model; a rate prediction unit that acquires data regarding the number of past visits to a store, a past sales volume, a menu feature, and a popular product to predict popularity of each product on the prediction target day, inputs the popularity to a trained sales rate prediction model, and predicts a sales rate of each product by using an output from the sales rate prediction model; and a sales volume prediction unit that predicts a sales volume of each product on the prediction target day by using the number of visits to a store predicted by the store visit number prediction unit and the sales rate of each product predicted by the rate prediction unit.

According to a second aspect of the present disclosure, there is provided a learning device including: a store visit number prediction training unit that trains a store visit number prediction model that receives, as an input, data regarding the number of past visits to a store and outputs the number of visits to a store on a prediction target day; and a rate prediction training unit that trains a sales rate prediction model that receives, as an input, the number of past visits to a store, a past sales volume, and past popularity for each product given using the number of past visits to a store, the past sales volume, and a menu feature, and outputs a sales rate of each product.

According to a third aspect of the present disclosure, there is provided a prediction method including: by a processor, acquiring data regarding the number of past visits to a store, inputting the data to a trained store visit number prediction model, and predicting the number of visits to a store on a prediction target day by using an output from the store visit number prediction model; acquiring data regarding the number of past visits to a store, a past sales volume, a menu feature, and a popular product to predict popularity of each product on the prediction target day, inputting the popularity to a trained sales rate prediction model, and predicting a sales rate of each product by using an output from the sales rate prediction model; and predicting a sales volume of each product on the prediction target day by using the predicted number of visits to a store and the predicted sales rate of each product.

According to a fourth aspect of the present disclosure, there is provided a learning method comprising: by a processor, training a store visit number prediction model that receives, as an input, data regarding the number of past visits to a store and outputs the number of visits to a store on a prediction target day; and training a sales rate prediction model that receives, as an input, the number of past visits to a store, a past sales volume, and past popularity for each product given using the number of past visits to a store, the past sales volume, and a menu feature, and outputs a sales rate of each product.

According to a fifth aspect of the present disclosure, there is provided a computer program for causing a computer to function as the prediction device according to the first aspect of the present disclosure or the learning device according to the second aspect of the present disclosure.

### Advantageous Effects of Invention

According to the disclosed technology, it is possible to provide a prediction device, a learning device, a prediction method, a learning method, and a computer program that are capable of performing prediction in consideration of the kind or a combination of products even in a case where a daily changing category exists in products to be provided.

### BRIEF DESCRIPTION OF DRAWINGS

FIG. 1 is a block diagram illustrating a hardware configuration of a learning device.

FIG. 2 is a block diagram illustrating an example of a functional configuration of a learning device.

FIG. 3 is a diagram illustrating an example of data stored in a past store visit number DB.

FIG. 4 is a diagram illustrating an example of data stored in an external environmental information DB.

FIG. 5 is a diagram illustrating an example of data stored in a past sales volume DB.

FIG. 6 is a diagram illustrating an example of data stored in a menu feature DB.

FIG. 7 is a diagram illustrating an example of data stored in a popular menu DB.

FIG. 8 is a block diagram illustrating a hardware configuration of a prediction device.

FIG. 9 is a block diagram illustrating an example of a functional configuration of a prediction device.

FIG. 10 is a diagram illustrating an example of data stored in a stock DB.

FIG. 11 is a flowchart illustrating an example of a flow of training processing performed by a learning device.

FIG. 12 is a flowchart illustrating an example of a flow of training processing performed by a learning device.

FIG. 13 is a flowchart illustrating an example of a flow of a prediction processing performed by a prediction device.

FIG. 14 is a flowchart illustrating an example of a flow of prediction processing performed by a prediction device.

FIG. 15 is a flowchart illustrating an example of a flow of prediction processing performed by a prediction device.

FIG. 16 is a flowchart illustrating an example of a flow of prediction processing performed by a prediction device.

FIG. 17 is a block diagram illustrating an example of a functional configuration of a learning device.

FIG. 18 is a diagram illustrating an example of data stored in a past sales volume DB.

FIG. 19 is a diagram illustrating an example of data stored in a sales time feature DB.

FIG. 20 is a block diagram illustrating an example of a functional configuration of a prediction device.

FIG. 21 is a flowchart illustrating an example of a flow of training processing performed by a learning device.

FIG. 22 is a flowchart illustrating an example of a flow of training processing performed by a learning device.

FIG. 23 is a flowchart illustrating an example of a flow of prediction processing performed by a prediction device.

FIG. 24 is a flowchart illustrating an example of a flow of prediction processing performed by a prediction device.

FIG. 25 is a flowchart illustrating an example of a flow of prediction processing performed by a prediction device.

FIG. 26 is a flowchart illustrating an example of a flow of prediction processing performed by a prediction device.

FIG. 27 is a block diagram illustrating an example of a functional configuration of a learning device.

FIG. 28 is a block diagram illustrating an example of a functional configuration of a prediction device.

FIG. 29 is a flowchart illustrating an example of a flow of training processing performed by a learning device.

FIG. 30 is a flowchart illustrating an example of a flow of prediction processing performed by a prediction device.

### DESCRIPTION OF EMBODIMENTS

Hereinafter, an example of an embodiment of the disclosed technology will be described with reference to the drawings. Note that, in the drawings, the same or equivalent components and portions are denoted by the same reference signs. Furthermore, dimensional ratios in the drawings are exaggerated for convenience of description, and may be different from actual ratios.

### First Embodiment

In the first embodiment, an example will be described in which in a case where one menu exists in one category as shown in Table 1, a unit of prediction is set to one day, and the sales volume of each menu on the day is predicted. However, even in a case where a plurality of menus exist in one category, the same method can be applied. Furthermore, even in a case where the unit of prediction is changed to one hour unit, a category unit, or the like, or a prediction target is changed to several days ahead, the same method can be applied. Furthermore, it is also conceivable to change a model or data according to a prediction target day. Note that the menu is an example of a product of the present disclosure.

TABLE 1

| Category | 2022 Apr. 1 | 2022 Apr. 2 | 2022 Apr. 3 | . . . |
|---|---|---|---|---|
| Category A | Menu A | Menu B | Menu A | . . . |
| Category B | Menu C | Menu D | Menu E | . . . |
| . . . | . . . | . . . | . . . | |

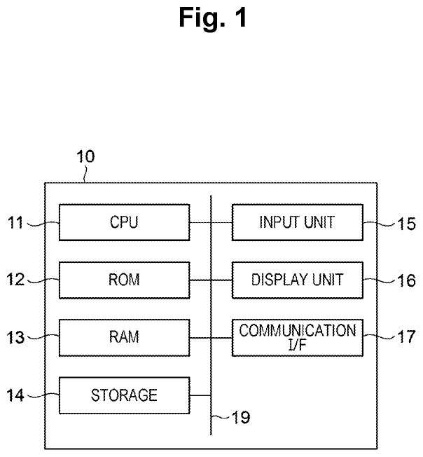

FIG. 1 is a block diagram illustrating a hardware configuration of a learning device 10. The learning device 10 according to the first embodiment is a device that trains a model for performing prediction in consideration of the kind or a combination of menus even in a case where a daily changing category exists in products to be provided.

As illustrated in FIG. 1, the learning device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 19.

The CPU 11 is a central processing unit, which executes various programs and controls each unit. That is, the CPU 11 reads a program from the ROM 12 or the storage 14, and executes the program using the RAM 13 as a working area. The CPU 11 performs control of each of the components described above and various types of arithmetic processing in accordance with the program stored in the ROM 12 or the storage 14. In the present embodiment, the ROM 12 or the storage 14 stores a training program for training a model for performing prediction in consideration of the type or a combination of menus.

The ROM 12 stores various programs and various types of data. The RAM 13, as the working area, temporarily stores a program or data. The storage 14 includes a storage device such as a hard disk drive (HDD) or solid state drive (SSD) and stores various programs including an operating system and various types of data.

The input unit 15 includes a pointing device such as a mouse and a keyboard and is used to perform various inputs.

The display unit 16 is, for example, a liquid crystal display and displays various types of information. The display unit 16 may also function as the input unit 15 by adopting a touch panel system.

The communication interface 17 is an interface for communicating with other devices. For the communication, for example, a wired communication standard such as Ethernet (registered trademark) or FDDI, or a wireless communication standard such as 4G, 5G, or Wi-Fi (registered trademark) is used.

Next, a functional configuration of the learning device 10 will be described.

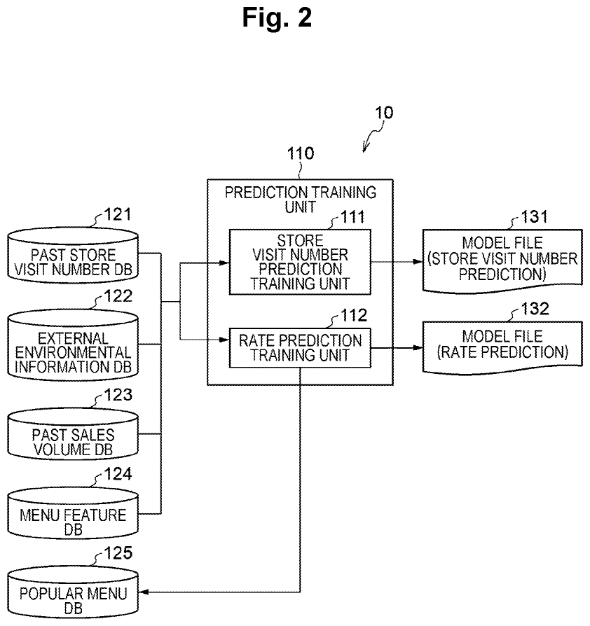

FIG. 2 is a block diagram illustrating an example of a functional configuration of the learning device 10.

As illustrated in FIG. 2, the learning device 10 includes a prediction training unit 110 as a functional configuration. Each functional configuration is realized by the CPU 11 reading the training program stored in the ROM 12 or the storage 14, deploying the training program in the RAM 13, and executing the training program.

The prediction training unit 110 trains a model file 131 for predicting the number of visits to a store such as a restaurant and a model file 132 for predicting a sales rate of products sold in the store. Here, the product is a menu of dishes in the case of a restaurant. Furthermore, the sales rate is a value calculated by dividing the sales volume of each menu by the number of visits to a store. The prediction training unit 110 includes a store visit number prediction training unit 111 and a rate prediction training unit 112.

The store visit number prediction training unit 111 performs machine learning using data recorded in a past store visit number DB 121, an external environmental information DB 122, a past sales volume DB 123, and a menu feature DB 124, and builds a model file 131 for predicting the number of visits to a store. When training the model file 131, the store visit number prediction training unit 111 builds the model file 131 by using a model applicable to a regression problem such as multiple regression analysis.

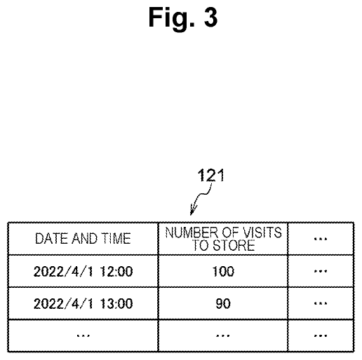

The past store visit number DB 121 is a database that records a date and time, the number of visits to a store for each date and time. FIG. 3 is a diagram illustrating an example of data stored in the past store visit number DB 121. The past store visit number DB 121 includes a date and time column and a store visit number column. In the date and time column, a store visit date and time is recorded in units of predetermined time intervals. An arbitrary time such as 10 minutes or one hour may be configured as a time interval. The same applies to other databases for the time interval.

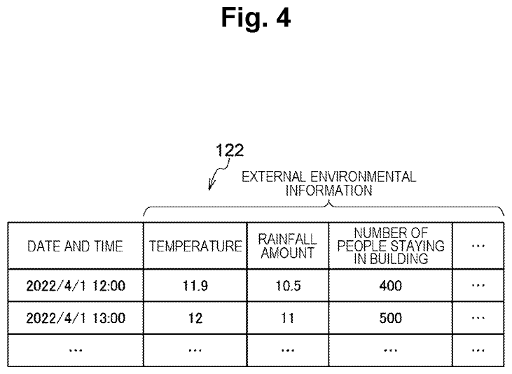

The external environmental information DB 122 is a database that records a date and time and external environmental information for each date and time. The external environmental information is information regarding an environment outside the store that affects the number of visits to a store. Examples of the external environmental information include weather, a temperature, a rainfall amount, a wind direction, a wind speed, humidity, the number of people staying in a building, and a peripheral people flow. FIG. 4 is a diagram illustrating an example of data stored in the external environmental information DB 122.

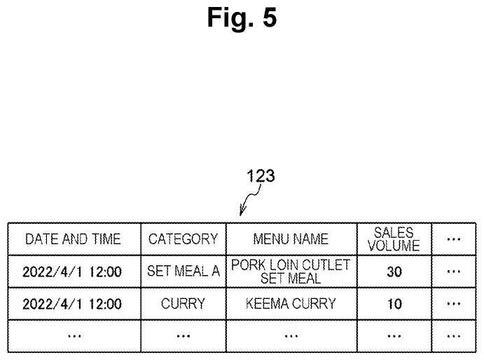

The past sales volume DB 123 is a database that records a date and time, a category of products sold for each date and time, a menu name, a sales volume, and the like. FIG. 5 is a diagram illustrating an example of data stored in the past sales volume DB 123. The past sales volume DB 123 includes a date and time column, a category column, a menu column, and a sales volume column.

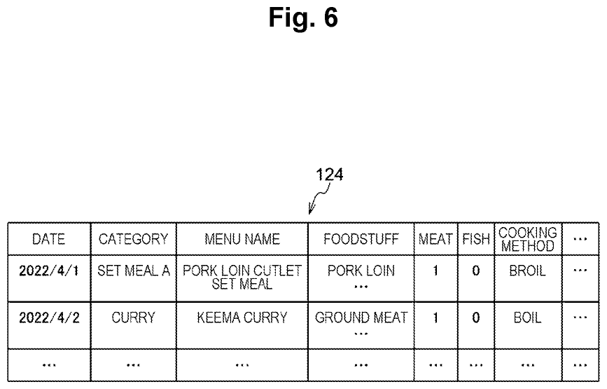

The menu feature DB 124 is a database that records menu features such as a date, a category, a menu name, a foodstuff, a meat flag, a fish flag, and a cooking method. FIG. 6 is a diagram illustrating an example of data stored in the menu feature DB 124. For example, for a pork loin cutlet set meal belonging to the category of a set meal A, pork loin is used, one is set for a meat flag to indicate that meat is used, zero is set for a fish flag to indicate that fish is not used, and to broil is stored in the menu feature DB 124 as a cooking method. Furthermore, for example, for a keema curry belonging to the category of a curry, ground meat is used, one is set for a meat flag to indicate that meat is used, zero is set for a fish flag to indicate that fish is not used, and to boil is stored in the menu feature DB 124 as a cooking method.

The store visit number prediction training unit 111 performs machine learning using information stored in each database and builds a model file 131 for predicting the number of visits to a store. Specifically, the store visit number prediction training unit 111 performs machine learning using a model applicable to a regression problem such as multiple regression analysis with the number of visits to a store per day as an objective variable and with external environments such as the number of visits to a store until the day before the prediction target day, the temperature on the day of the prediction target day, and the number of people staying in a building as explanatory variables, and builds the model file 131 for predicting the number of visits to a store. The range of a period of data for machine learning in the store visit number prediction training unit 111 can be arbitrarily set.

The rate prediction training unit 112 performs popular menu determination by using data recorded in the past store visit number DB 121, the external environmental information DB 122, the past sales volume DB 123, and the menu feature DB 124, and builds a model file 132 for predicting a sales rate of products by further performing the machine learning. The range of a period of data for machine learning in the rate prediction training unit 112 can be arbitrarily set.

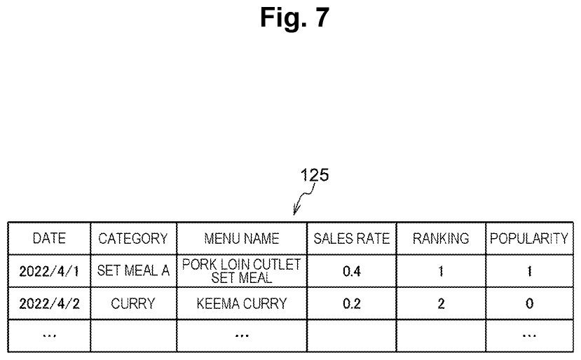

The rate prediction training unit 112 acquires data recorded in the past store visit number DB 121 and the past sales volume DB 123, and calculates a sales rate of each menu on a daily basis by dividing the sales volume of each menu by the number of visits to a store. Then, the rate prediction training unit 112 ranks the sales rate of each menu for each day and writes the ranking in a popular menu DB 125. FIG. 7 is a diagram illustrating an example of data stored in the popular menu DB 125. The popular menu DB 125 is a database that records a date, a category, a menu name, a sales rate, ranking, popularity, and the like. The popularity is recorded in the popular menu DB 125 as a flag of zero or one, or a numerical value of a value range [0,1]. The rate prediction training unit 112 determines the popularity of each menu on the basis of the sales rate of each menu.

Then, the rate prediction training unit 112 performs machine learning using a model applicable to a regression problem such as multiple regression analysis with the sales rate of each menu on a daily basis as an objective variable and with the sales rate until the day before the prediction target day, the calculated popularity, the menu feature, and the external environment on the day of the prediction target day as explanatory variables, and builds the model file 132 for predicting the sales rate of the product. For example, the rate prediction training unit 112 builds one prediction model for each category by collecting data of the same category, but may build a prediction model for each menu by collecting only data of the same menu. For example, building one prediction model for each category by collecting data of the same category means building a prediction model that predicts a sales rate of a category A by collecting data of the category A, and a menu belonging to the category A is a menu that can be changed daily, for example, the menu is a menu A on one day and the menu is a menu B on another day.

With such a configuration, the learning device 10 can generate a trained model for improving the prediction accuracy of the sales volume as compared with the case of using the conventional technology as it is by performing prediction in consideration of the type or a combination of the menus even in a case where a daily changing category exists in the products to be provided.

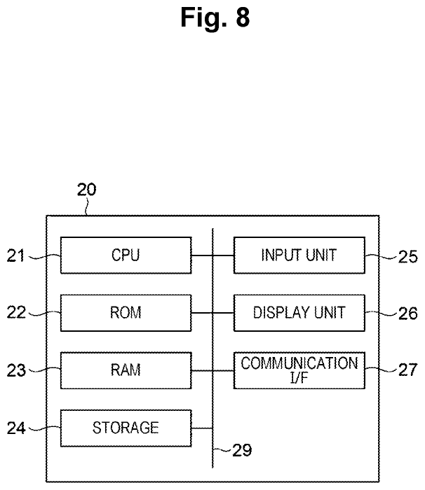

FIG. 8 is a block diagram illustrating a hardware configuration of a prediction device 20. The prediction device 20 according to the first embodiment is a device that performs prediction in consideration of the kind or a combination of menus even in a case where a daily changing category exists in products to be provided.

As illustrated in FIG. 8, the prediction device 20 includes a CPU 21, a ROM 22, a RAM 23, a storage 24, an input unit 25, a display unit 26, and a communication interface (I/F) 27. The components are communicably connected to each other via a bus 29.

The CPU 21 is a central processing unit, which executes various programs and controls each unit. That is, the CPU 21 reads a program from the ROM 22 or the storage 24, and executes the program using the RAM 23 as a working area. The CPU 21 performs control of each of the components described above and various types of arithmetic processing in accordance with the program stored in the ROM 22 or the storage 24. In the present embodiment, the ROM 22 or the storage 24 stores a prediction program for performing prediction in consideration of the type or a combination of menus.

The ROM 22 stores various programs and various types of data. The RAM 23, as the working area, temporarily stores programs or data. The storage 24 includes a storage device such as an HDD or an SSD, and stores various programs including an operating system and various types of data.

The input unit 25 includes a pointing device such as a mouse and a keyboard and is used to perform various inputs.

The display unit 26 is, for example, a liquid crystal display, and displays various types of information. The display unit 26 may function as the input unit 25 by adopting a touch panel system.

The communication interface 27 is an interface for communicating with other devices. For the communication, for example, a wired communication standard such as Ethernet (registered trademark) or FDDI, or a wireless communication standard such as 4G, 5G, or Wi-Fi (registered trademark) is used.

Next, a functional configuration of the prediction device 20 will be described.

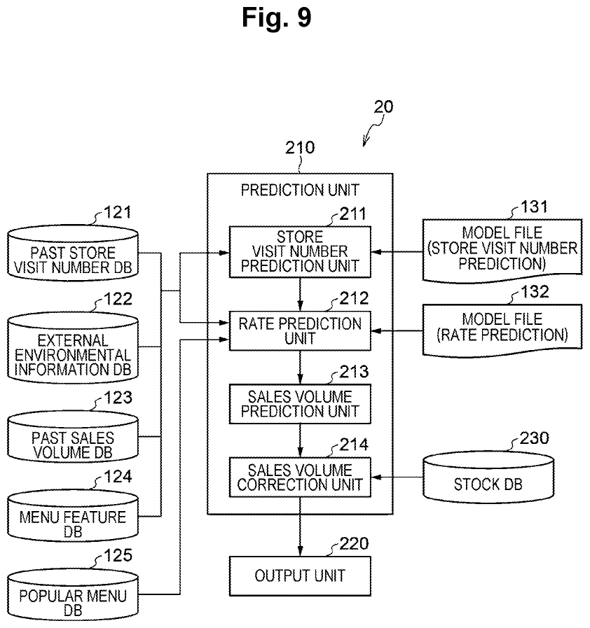

FIG. 9 is a block diagram illustrating an example of the functional configuration of the prediction device 20.

As illustrated in FIG. 9, the prediction device 20 includes a prediction unit 210 and an output unit 220 as a functional configuration. Each functional configuration is realized by the CPU 21 reading the prediction program stored in the ROM 22 or the storage 24, deploying the prediction program in the RAM 23, and executing the training program.

The prediction unit 210 predicts a sales volume of each menu on the prediction target day by using a model file 131 for predicting the number of visits to a store such as a restaurant and a model file 132 for predicting a sales rate of products sold in the store. The prediction unit 210 includes a store visit number prediction unit 211, a rate prediction unit 212, a sales volume prediction unit 213, and a sales volume correction unit 214.

The store visit number prediction unit 211 predicts the number of visits to a store on the prediction target day on the basis of a value output from the model file 131 by using data recorded in the past store visit number DB 121, the external environmental information DB 122, the past sales volume DB 123, and the menu feature DB 124 and the model file 131.

The rate prediction unit 212 predicts a sales rate of each menu on the prediction target day on the basis of a value output from the model file 132 by using data recorded in the past store visit number DB 121, the external environmental information DB 122, the past sales volume DB 123, the menu feature DB 124, and the popular menu DB 125, and the model file 132.

The rate prediction unit 212 predicts popularity of each menu on the day of the prediction target day in consideration of a combination of menus. Here, the most popular menu is predicted as popularity=1, and the other menus are predicted as popularity=0. An example of prediction processing of the popularity of each menu by the rate prediction unit 212 will be described.

(1) The rate prediction unit 212 vectorizes menu names in a training period and a prediction period, and performs grouping (processing of grouping similar menus) by using similarity. For example, the rate prediction unit 212 vectorizes the menu names with Bag of Words, and groups menus having similarity equal to or larger than a threshold by using cosine similarity. Thus, improvement in accuracy can be expected in a case where menu names are fluctuated, for example, “Whitish Deep-fried Chicken” and “Whitish Deep-fried Chicken Meat” or there is a large variety of menus. However, in a case where there is no fluctuation in menu or in a case where it is desired to distinguish even a slight difference in menu name, the rate prediction unit 212 may proceed to the processing of the next (2) without performing the processing of (1).

(2) Subsequently, the rate prediction unit 212 determines superiority or inferiority among menus by using the past sales rate data for each menu on the day of the prediction target day, and predicts a popular menu candidate with popularity=1. The rate prediction unit 212 may rank menus by performing, for example, ranking training, and use a high-order menu as a popular menu candidate, or may retrieve direct comparison data among menus, and determine whether or not to leave the data as a popular menu candidate.

(3) Subsequently, in a case where there is a plurality of popular menu candidates, the rate prediction unit 212 further narrows down the candidates according to the past popularity, and predicts a popular menu (popularity=1). For example, the rate prediction unit 212 may predict the most recent menu having high popularity as a popular menu (popularity=1), or may predict the menu by performing weighting with an average, variance, the number of times of appearance, or the like of popularity of the candidate menu. However, in a case where the result of the processing of (2) is directly used as a prediction value, the rate prediction unit 212 may end the processing without performing the processing of (3).

When predicting the popularity of each menu on the day of the prediction target day, the rate prediction unit 212 adds the predicted popularity to the explanatory variable, and predicts the sales rate of each menu on the day of the prediction target day by using the read model file 132.

The sales volume prediction unit 213 calculates the predicted sales volume of each menu on the prediction target day by multiplying the number of visits to a store on the prediction target day predicted by the store visit number prediction unit 211 by the sales rate of each menu on the day of the prediction target day predicted by the rate prediction unit 212.

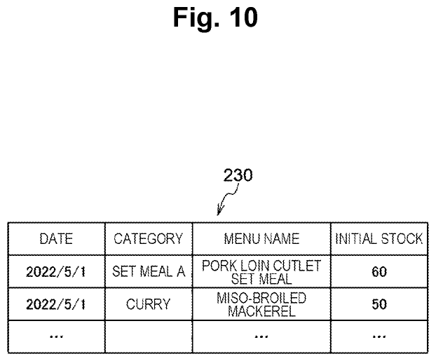

The sales volume correction unit 214 corrects the predicted sales volume of each menu on the prediction target day predicted by the sales volume prediction unit 213 by using the stock information of each menu recorded in a stock DB 230. The stock DB 230 is a database that records a date, a category, a menu name, stock data for an initial stock, and the like. FIG. 10 is a diagram illustrating an example of data stored in the stock DB 230.

An example of the sales volume correction processing performed by the sales volume correction unit 214 will be described. First, the total distribution is set to zero. For Predicted sales volume>Initial stock for the menu, the sales volume correction unit 214 sets Predicted sales volume=Initial stock, and adds a quantity exceeding the initial stock to the total distribution. On the other hand, when Predicted sales volume≤Initial stock for the menu, the sales volume correction unit 214 calculates the distribution rate from the predicted sales rate of each menu such that the total becomes one. Furthermore, when Predicted sales volume≤Initial stock for the menu, the sales volume correction unit 214 corrects the predicted sales volume by setting Predicted sales volume=Predicted sales volume+Total distribution×Distribution rate for each menu.

Note that in a case where the initial stock cannot be acquired from the stock DB 230, the sales volume correction processing performed by the sales volume correction unit 214 may be skipped.

The output unit 220 presents the sales volume of each menu on the prediction target day predicted by the sales volume prediction unit 213 and corrected by the sales volume correction unit 214 to a user.

With such a configuration, the prediction device 20 can improve the prediction accuracy of the sales volume as compared with the case of using the conventional technology as it is by performing prediction in consideration of the type or a combination of the menus even in a case where a daily changing category exists in the products to be provided.

Next, actions of the learning device 10 will be described.

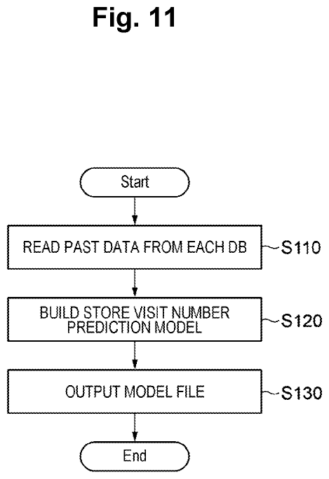

FIG. 11 is a flowchart illustrating an example of a flow of training processing performed by the learning device 10. The training processing is performed by the CPU 11 reading a training program from the ROM 12 or the storage 14, deploying the training program in the RAM 13, and executing the training program. FIG. 11 illustrates a flowchart when the learning device 10 builds the model file 131 for predicting the number of visits to a store.

In step S110, the CPU 11 acquires data recorded in the past store visit number DB 121, the external environmental information DB 122, the past sales volume DB 123, and the menu feature DB 124. An arbitrary period can be set as the acquisition target period.

Subsequent to step S110, in step S120, the CPU 11 performs machine learning using a model applicable to a regression problem such as multiple regression analysis with the number of visits to a store per day as an objective variable and with the number of visits to a store until the day before the prediction target day, the temperature on the day of the prediction target day, and the number of people staying in a building as explanatory variables, and builds the model file 131 for predicting the number of visits to a store.

Subsequent to step S120, in step S130, the CPU 11 outputs the built model file 131 as an external file.

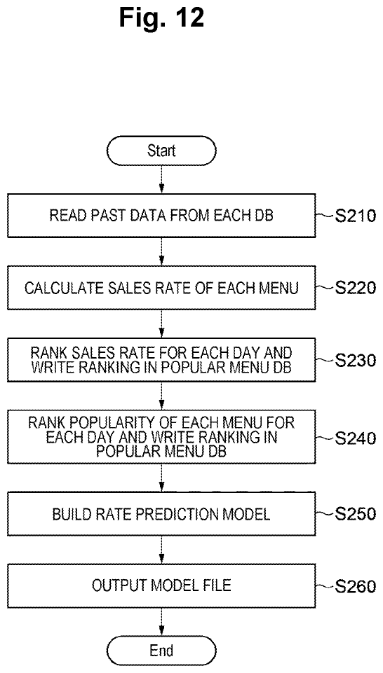

FIG. 12 is a flowchart illustrating an example of a flow of training processing performed by the learning device 10. The training processing is performed by the CPU 11 reading a training program from the ROM 12 or the storage 14, deploying the training program in the RAM 13, and executing the training program. FIG. 12 illustrates a flowchart when the learning device 10 builds the model file 132 for predicting the sales rate.

In step S210, the CPU 11 acquires data recorded in the past store visit number DB 121, the external environmental information DB 122, the past sales volume DB 123, and the menu feature DB 124. An arbitrary period can be set as the acquisition target period.

Subsequent to step S210, in step S220, the CPU 11 calculates the sales rate of each menu on a daily basis by dividing the sales volume of each menu by the number of visits to a store.

Subsequent to step S220, in step S230, the CPU 11 ranks the sales rate of each menu for each day and writes the ranking in the popular menu DB 125.

Subsequent to step S230, in step S240, the CPU 11 ranks the popularity of each menu for each day and writes the ranking in the popular menu DB 125. The popularity is recorded as a flag of zero or one, or a numerical value of a value range [0.1].

Subsequent to step S240, in step S250, the CPU 11 performs machine learning using a model applicable to a regression problem such as multiple regression analysis with the sales rate of each menu on a daily basis as an objective variable and with the sales rate until the day before the prediction target day, the calculated popularity, the menu feature, and the external environment on the day of the prediction target day as explanatory variables, and builds the model file 132 for predicting the sales rate of the product.

Subsequent to step S250, in step S260, the CPU 11 outputs the built model file 132 as an external file.

Next, actions of the prediction device 20 will be described.

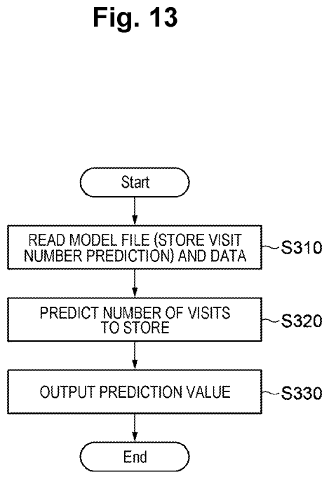

FIG. 13 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 13 illustrates a flowchart when the prediction device 20 predicts the number of visits to a store on the prediction target day by using the model file 131.

In step S310, the CPU 21 acquires data recorded in the past store visit number DB 121, the external environmental information DB 122, the past sales volume DB 123, and the menu feature DB 124 and the model file 131.

Subsequent to step S310, in step S320, the CPU 21 inputs the data acquired from each database to the model file 131, and predicts the number of visits to a store on the prediction target day on the basis of a value output from the model file 131.

Subsequent to step S320, in step S330, the CPU 21 outputs the number of visits to a store on the prediction target day, which is predicted in step S320.

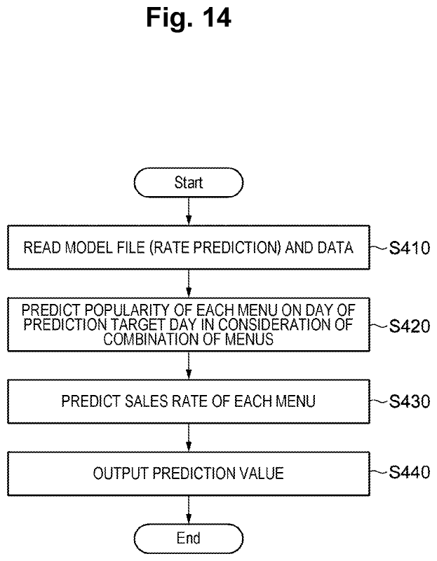

FIG. 14 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 14 illustrates a flowchart when the prediction device 20 predicts the sales rate of each menu on the prediction target day by using the model file 132.

In step S410, the CPU 21 acquires data recorded in the past store visit number DB 121, the external environmental information DB 122, the past sales volume DB 123, and the menu feature DB 124 and the model file 132.

Subsequent to step S410, in step S420, the CPU 21 predicts popularity of each menu on the day of the prediction target day in consideration of a combination of menus. For example, the CPU 21 predicts the popularity of each menu on the day of the prediction target day by the processing described in the description of the rate prediction unit 212 described above.

Subsequent to step S420, in step S430, the CPU 21 adds the popularity calculated in step S420 to the explanatory variable, and predicts the sales rate of each menu on the day of the prediction target day by using the read model file 132.

Subsequent to step S430, in step S440, the CPU 21 outputs the sales rate of each menu on the day of the prediction target day, which is predicted in step S430.

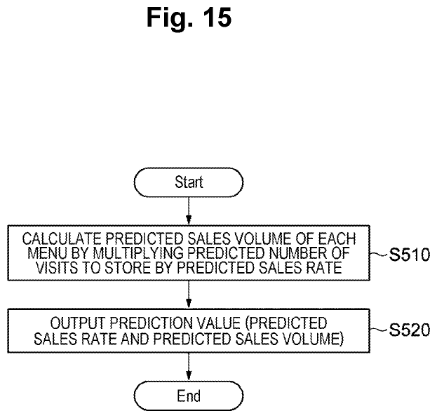

FIG. 15 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 15 illustrates a flowchart when the prediction device 20 predicts the sales volume of each menu on the prediction target day.

In step S510, the CPU 21 calculate the predicted sales volume of each menu by multiplying a prediction value of the number of visits to a store on the day of the prediction target day, which is output in step S330, by a prediction value of the sales rate of each menu on the day of the prediction target day, which is output in step S440.

Subsequent to step S510, in step S520, the CPU 21 outputs the prediction values of the sales rate and sales volume of each menu on the day of the prediction target day.

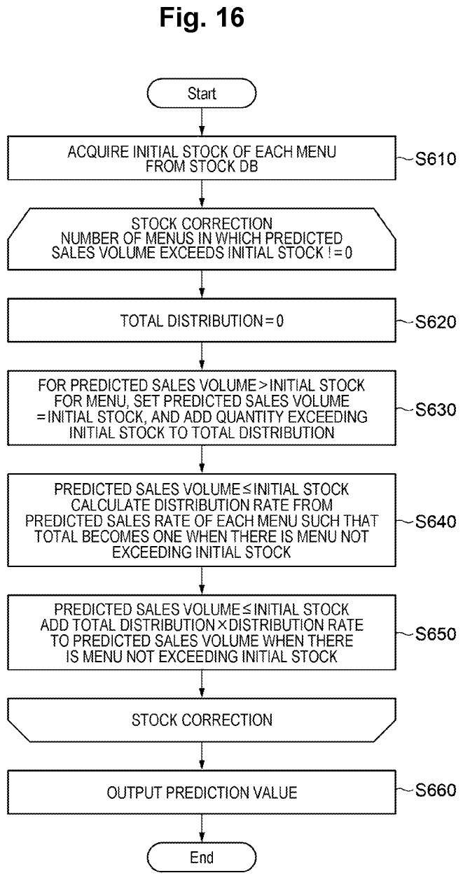

FIG. 16 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 16 illustrates a flowchart when the prediction device 20 corrects the predicted sales volume of each menu on the prediction target day.

In step S610, the CPU 21 acquires an initial stock of each menu from the stock DB 230.

Subsequent to step S610, in step S620, the CPU 21 set the total distribution=0.

Subsequent to step S620, in step S630, for Predicted sales volume>Initial stock for the menu, the CPU 21 sets Predicted sales volume=Initial stock, and adds a quantity exceeding the initial stock to the total distribution.

Subsequent to step S630, in step S640, when Predicted sales volume≤Initial stock for the menu, the CPU 21 calculates the distribution rate from the predicted sales rate of each menu such that the total becomes one.

Subsequent to step S640, in step S650, when Predicted sales volume≤Initial stock for the menu, the CPU 21 sets Predicted sales volume=Predicted sales volume+Total distribution×Distribution rate for each menu.

The CPU 21 executes processing from step S620 to step S650 on all the menus. When the processing from step S620 to step S650 are executed for all the menus, the CPU 21 outputs the corrected predicted sales volume in step S660, subsequent to step S650.

Note that in a case where the information regarding the initial stock cannot be acquired, for example, in a case where the initial stock is unknown, the CPU 21 may not execute the series of processing illustrated in FIG. 16.

By executing the processing, the prediction device 20 can improve the prediction accuracy of the sales volume as compared with the case of using the conventional technology as it is by performing prediction in consideration of the type or a combination of the menus even in a case where a daily changing category exists in the products to be provided.

### Second Embodiment

In a second embodiment, an example will be described in which in a case where one menu exists in one category as shown in Table 1, a unit of prediction is set to one day, and the sales volume of each menu on the day is predicted. However, even in a case where a plurality of menus exist in one category, the same method can be applied. Furthermore, even in a case where the unit of prediction is changed to one hour unit, a category unit, or the like, or a prediction target is changed to several days ahead, the same method can be applied. Furthermore, it is also conceivable to change a model or data according to a prediction target day.

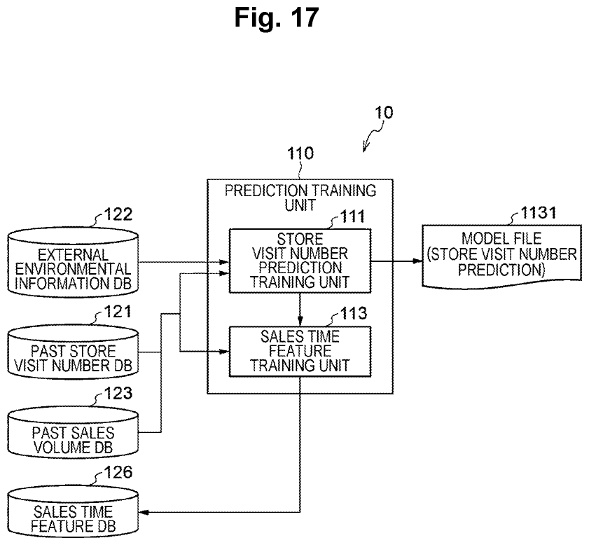

FIG. 17 is a block diagram illustrating an example of the functional configuration of the learning device 10. The learning device 10 according to the second embodiment is a device that trains a model for performing prediction in consideration of a sales state for each menu.

As illustrated in FIG. 17, the learning device 10 includes a prediction training unit 110 as a functional configuration. Each functional configuration is realized by the CPU 11 reading the training program stored in the ROM 12 or the storage 14, deploying the training program in the RAM 13, and executing the training program.

The prediction training unit 110 trains a model file 1131 for predicting the number of visits to a store such as a restaurant. Here, the product is a menu of dishes in the case of a restaurant. The prediction training unit 110 includes a store visit number prediction training unit 11 and a sales time feature training unit 113.

The store visit number prediction training unit 111 performs machine learning using data recorded in a past store visit number DB 121, an external environmental information DB 122, and a past sales volume DB 123, and builds a model file 1131 for predicting the number of visits to a store. When training the model file 1131, the store visit number prediction training unit 111 builds the model file 1131 by using a model applicable to a regression problem such as multiple regression analysis.

As illustrated in FIG. 3, the past store visit number DB 121 is a database that records a date and time, the number of visits to a store for each date and time. As illustrated in FIG. 4, the external environmental information DB 122 is a database that records a date and time and external environmental information for each date and time. Examples of the external environmental information include weather, a temperature, a rainfall amount, a wind direction, a wind speed, humidity, the number of people staying in a building, and a peripheral people flow.

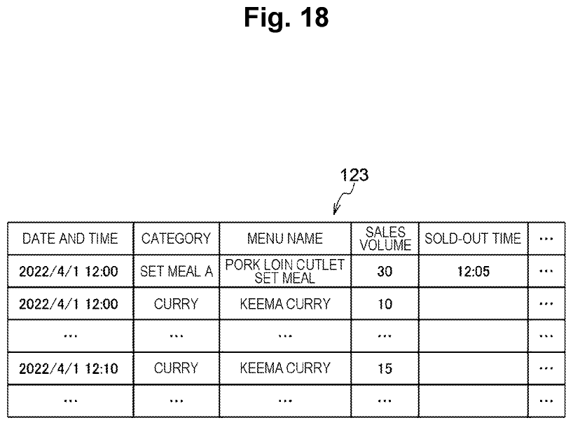

The past sales volume DB 123 is a database that records a date and time, a category of products sold for each date and time, a menu name, a sales volume, and the like. FIG. 18 is a diagram illustrating an example of data stored in the past sales volume DB 123. The past sales volume DB 123 includes a date and time column, a category column, a menu column, a sales volume column, and a sold-out time column.

The sales time feature training unit 113 calculates sales time feature by using data recorded in the past store visit number DB 121 and the past sales volume DB 123.

The sales time feature training unit 113 calculates a ratio of a sales rate between a cumulative sales rate at each time and the total daily sales volume, for each menu and each day. Each time is set, for example, to every 10 minutes or every 30 minutes, and the sales rate is calculated by dividing the sales volume of each menu by the number of visits to a store. The sales time feature training unit 113 calculates a ratio (sales time feature at each time) by excluding the influence of sold-out. For example, the sales time feature training unit 113 calculates the ratio in the following flow.

(1) The sales time feature training unit 113 extracts only data of a menu in which the sold-out does not finally occur, from the calculated sales rate.

(2) Next, for each of a cumulative sales rate at each time and a final sales rate, the sales time feature training unit 113 perform correction by multiplying each sales rate by “1/total sales rate” such that the daily total becomes one, and calculates “cumulative sales rate_correction” and “sales rate_correction”.

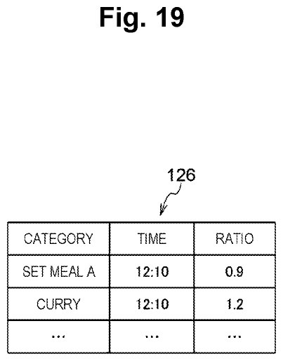

(3) Next, the sales time feature training unit 113 calculates (sales rate_correction/cumulative sales rate at each time_correction) for each time and category, and averages the calculated results over the entire training period as a ratio of each time and category. The sales time feature training unit 113 writes the ratio of each time for each category in a sales time feature DB 126. FIG. 19 is a diagram illustrating an example of data stored in the sales time feature DB 126.

With such a configuration, the learning device 10 can generate a trained model for improving the prediction accuracy of the sales volume as compared with the case of using the conventional technology as it is in consideration of a sales state for each menu.

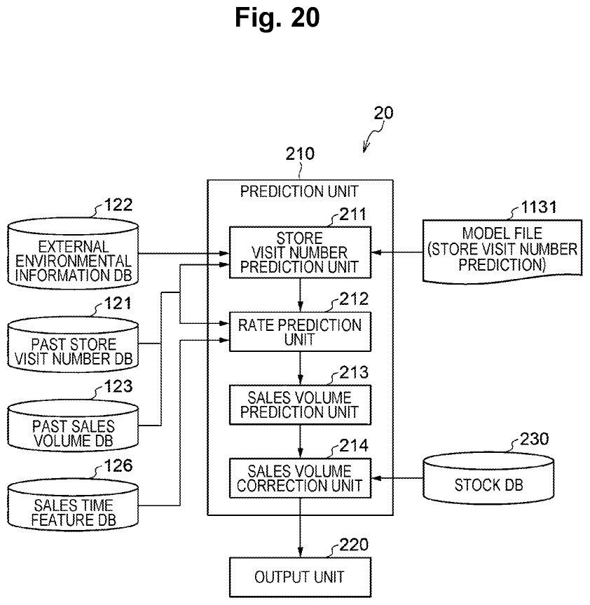

FIG. 20 is a block diagram illustrating an example of the functional configuration of the prediction device 20. The prediction device 20 according to the second embodiment is a device that performs prediction in consideration of the sales state for each menu.

As illustrated in FIG. 20, the prediction device 20 includes a prediction unit 210 and an output unit 220 as a functional configuration. Each functional configuration is realized by the CPU 21 reading the prediction program stored in the ROM 22 or the storage 24, deploying the prediction program in the RAM 23, and executing the training program.

The prediction unit 210 predicts a sales volume of each menu on the prediction target day by using the model file 1131 for predicting the number of visits to a store such as a restaurant. The prediction unit 210 includes a store visit number prediction unit 211, a rate prediction unit 212, a sales volume prediction unit 213, and a sales volume correction unit 214.

The store visit number prediction unit 211 predicts the number of visits to a store on the prediction target day on the basis of a value output from the model file 1131 by using data recorded in the past store visit number DB 121, the external environmental information DB 122, and the past sales volume DB 123, and the model file 1131.

The rate prediction unit 212 predicts a sales rate of each menu on the prediction target day by using data recorded in the past store visit number DB 121, the past sales volume DB 123, and the sales time feature DB 126. The rate prediction unit 212 predicts a sales rate in consideration of the presence or absence of occurrence of sold-out of each menu by using data recorded in the past sales volume DB 123. Note that the prediction in consideration of the presence or absence of occurrence of sold-out of each menu by the rate prediction unit 212 includes prediction in consideration of a sold-out time in a case where the sold-out occurs.

The rate prediction unit 212 reads the past data and ratios and the data and ratios on the prediction target day from the past sales volume DB 123 and the sales time feature DB 126. The rate prediction unit 212 calculates the cumulative sales rate of each menu on the basis of data at the designated time on the day of the prediction target day. For example, the designated time is set to a time during business hours of the target restaurant, for example, 12:30. Then, the rate prediction unit 212 predicts a sales rate of each menu by using the calculated cumulative sales rate and the ratio for each menu recorded in the sales time feature DB 126. The rate prediction unit 212 calculates the sales rate by a method of multiplying the cumulative sales rate of each menu at the designated time by the ratio of each menu at the designated time.

The sales volume prediction unit 213 calculates the predicted sales volume of each menu on the prediction target day by multiplying the number of visits to a store on the prediction target day predicted by the store visit number prediction unit 211 by the sales rate of each menu on the day of the prediction target day predicted by the rate prediction unit 212.

The sales volume correction unit 214 corrects the predicted sales volume of each menu on the prediction target day predicted by the sales volume prediction unit 213 by using the stock information of each menu recorded in a stock DB 230 illustrated in FIG. 10. The stock DB 230 is a database that records a date, a category, a menu name, stock data for an initial stock, and the like.

An example of the sales volume correction processing performed by the sales volume correction unit 214 will be described. First, the total distribution is set to zero. For Predicted sales volume>Initial stock for the menu, the sales volume correction unit 214 sets Predicted sales volume=Initial stock, and adds a quantity exceeding the initial stock to the total distribution. On the other hand, when Predicted sales volume≤Initial stock for the menu, the sales volume correction unit 214 calculates the distribution rate from the predicted sales rate of each menu such that the total becomes one. Furthermore, when Predicted sales volume≤Initial stock for the menu, the sales volume correction unit 214 corrects the predicted sales volume by setting Predicted sales volume=Predicted sales volume+Total distribution×Distribution rate for each menu.

Note that in a case where the initial stock cannot be acquired from the stock DB 230, the sales volume correction processing performed by the sales volume correction unit 214 may be skipped.

The output unit 220 presents the sales volume of each menu on the prediction target day predicted by the sales volume prediction unit 213 and corrected by the sales volume correction unit 214 to a user.

With such a configuration, the prediction device 20 can improve the prediction accuracy of the sales volume as compared with the case of using the conventional technology as it is in consideration of a sales state for each menu.

Next, actions of the learning device 10 will be described.

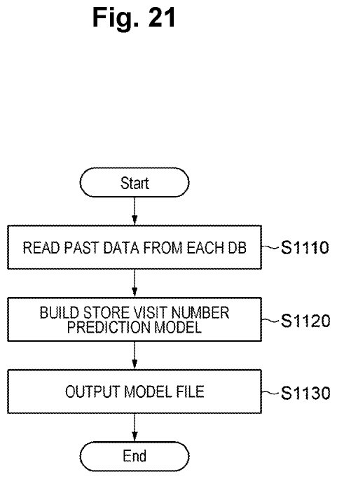

FIG. 21 is a flowchart illustrating an example of a flow of training processing performed by the learning device 10. The training processing is performed by the CPU 11 reading a training program from the ROM 12 or the storage 14, deploying the training program in the RAM 13, and executing the training program. FIG. 21 illustrates a flowchart when the model file 1131 for predicting the number of visits to a store is built.

In step S1110, the CPU 11 acquires data recorded in the past store visit number DB 121, the external environmental information DB 122, and the past sales volume DB 123. An arbitrary period can be set as the acquisition target period.

Subsequent to step S1110, in step S1120, the CPU 11 performs machine learning using a model applicable to a regression problem such as multiple regression analysis with the number of visits to a store per day as an objective variable and with the number of visits to a store until the day before the prediction target day, the temperature on the day of the prediction target day, and the number of people staying in a building as explanatory variables, and builds the model file 1131 for predicting the number of visits to a store.

Subsequent to step S1120, in step S1130, the CPU 11 outputs the built model file 1131 as an external file.

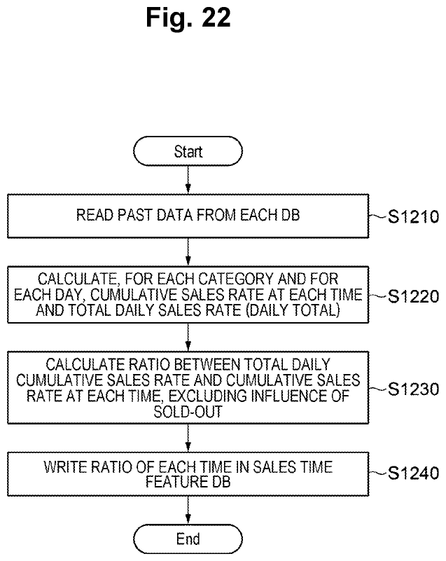

FIG. 22 is a flowchart illustrating an example of a flow of training processing performed by the learning device 10. The training processing is performed by the CPU 11 reading a training program from the ROM 12 or the storage 14, deploying the training program in the RAM 13, and executing the training program. FIG. 22 illustrates a flowchart when the learning device 10 calculates the feature of the sales time.

In step S1210, the CPU 11 acquires data recorded in the past store visit number DB 121 and the past sales volume DB 123. An arbitrary period can be set as the acquisition target period.

Subsequent to step S1210, in step S1220, the CPU 11 calculates, for each category and for each day, a sales rate between the cumulative sales rate at each time and the total daily sales volume. Each time is set, for example, to every 10 minutes or every 30 minutes, and the sales rate is calculated by dividing the sales volume of each menu by the number of visits to a store.

Subsequent to step S1220, in step S1230, the CPU 11 calculates a ratio of a sales rate between the cumulative sales rate at each time and the total daily sales volume, excluding the influence of the sold-out. The CPU 11 calculates the ratio (sales time feature at each time) by, for example, processing described in the description of the sales time feature training unit 113 described above.

Subsequent to step S1230, in step S1240, the CPU 11 writes the calculated ratio at each time in the sales time feature DB 126.

With such processing, the learning device 10 can generate a trained model for improving the prediction accuracy of the sales volume as compared with the case of using the conventional technology as it is in consideration of a sales state for each menu.

Next, actions of the prediction device 20 will be described.

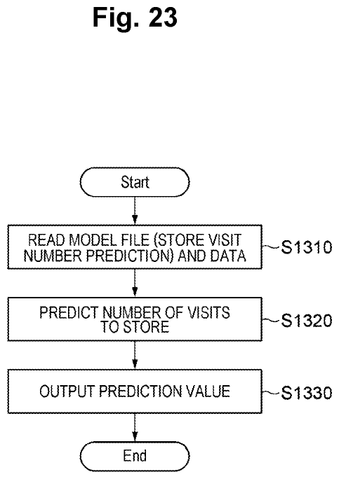

FIG. 23 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 23 illustrates a flowchart when the prediction device 20 predicts the number of visits to a store on the prediction target day by using the model file 131.

In step S1310, the CPU 21 acquires data recorded in the past store visit number DB 121, the external environmental information DB 122, and the past sales volume DB 123, and the model file 1131.

Subsequent to step S1310, in step S1320, the CPU 21 inputs the data acquired from each database to the model file 1131, and predicts the number of visits to a store on the prediction target day on the basis of a value output from the model file 1131.

Subsequent to step S1320, in step S1330, the CPU 21 outputs the number of visits to a store on the prediction target day, which is predicted in step S1320.

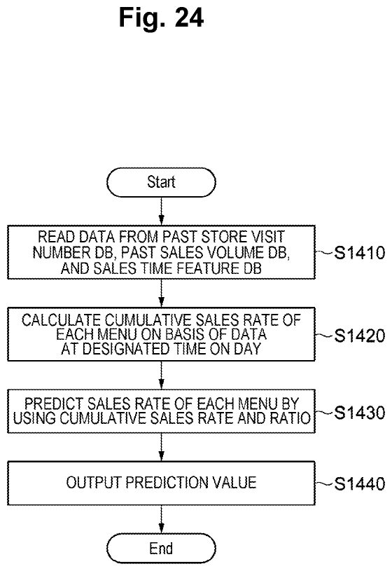

FIG. 24 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 24 illustrates a flowchart when the prediction device 20 predicts the sales rate of each menu on the prediction target day by using the model file 132.

In step S1410, the CPU 21 acquires data recorded in the past store visit number DB 121, the past sales volume DB 123, and the sales time feature DB 126.

Subsequent to step S1410, in step S1420, the CPU 21 calculates the cumulative sales rate of each menu on the basis of data at the designated time on the day of the prediction target day. For example, the designated time is set to a time during business hours of the target restaurant, for example, 12:30.

Subsequent to step S1420, in step S1430, the CPU 21 predicts a sales rate of each menu by using the cumulative sales rate calculated in step S1420 and the ratio for each menu recorded in the sales time feature DB 126. The CPU 21 calculates the sales rate by a method of multiplying the cumulative sales rate of each menu at the designated time by the ratio of each menu at the designated time.

Subsequent to step S1430, in step S1440, the CPU 21 outputs the sales rate of each menu on the prediction target day, which is predicted in step S1430.

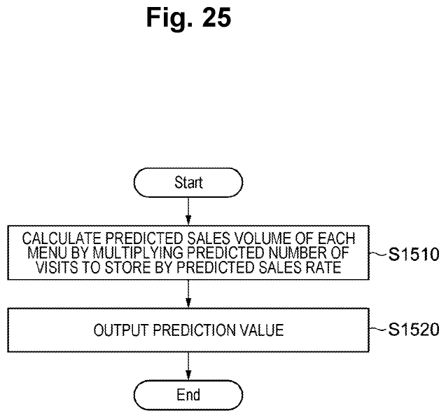

FIG. 25 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 25 illustrates a flowchart when the prediction device 20 predicts a sales volume of each menu on the prediction target day.

In step S1510, the CPU 21 calculates the predicted sales volume of each menu by multiplying a prediction value of the number of visits to a store on the day of the prediction target day, which is output in step S1330 by a prediction value of the sales rate of each menu on the day of the prediction target day, which is output in step S1440.

Subsequent to step S1510, in step S1520, the CPU 21 outputs the prediction values of the sales rate and sales volume of each menu on the day of the prediction target day.

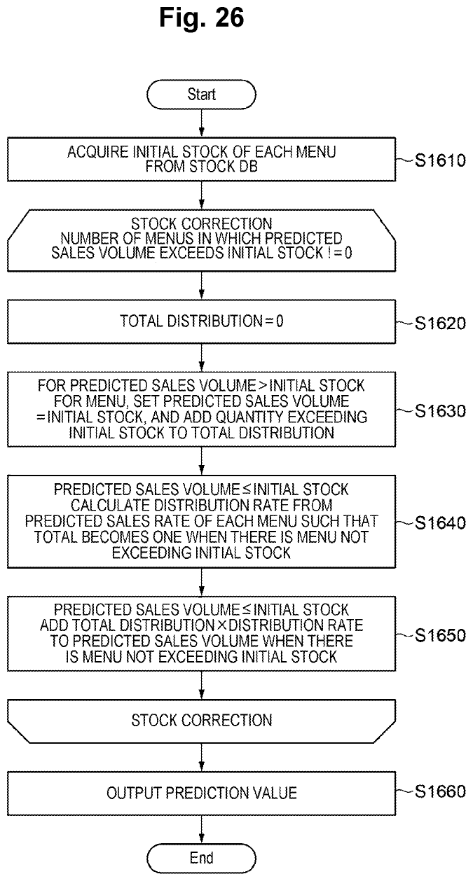

FIG. 26 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 26 illustrates a flowchart when the prediction device 20 corrects the predicted sales volume of each menu on the prediction target day.

In step S1610, the CPU 21 acquires an initial stock of each menu from the stock DB 230.

Subsequent to step S1610, in step S1620, the CPU 21 set the total distribution=0.

Subsequent to step S1620, in step S1630, for Predicted sales volume>Initial stock for the menu, the CPU 21 sets Predicted sales volume=Initial stock, and adds a quantity exceeding the initial stock to the total distribution.

Subsequent to step S1630, in step S1640, when Predicted sales volume≤Initial stock for the menu, the CPU 21 calculates the distribution rate from the predicted sales rate of each menu such that the total becomes one.

Subsequent to step S1640, in step S1650, when Predicted sales volume≤Initial stock for the menu, the CPU 21 sets Predicted sales volume=Predicted sales volume+Total distribution×Distribution rate for each menu.

The CPU 21 executes processing from step S1620 to step S1650 on all the menus. When the processing from step S1620 to step S1650 are executed for all the menus, the CPU 21 outputs the corrected predicted sales volume in step S1660, subsequent to step S1650.

Note that in a case where the information regarding the initial stock cannot be acquired, for example, in a case where the initial stock is unknown, the CPU 21 may not execute the series of processing illustrated in FIG. 26.

With such processing, the prediction device 20 can improve the prediction accuracy of the sales volume as compared with the case of using the conventional technology as it is in consideration of a sales state for each menu.

### Third Embodiment

Also in a third embodiment, an example will be described in which in a case where one menu exists in one category as shown in Table 1, a unit of prediction is set to one day, and the sales volume of each menu on the day is predicted. Furthermore, the present embodiment is an embodiment in a case where the initial stock of the menu can be acquired.

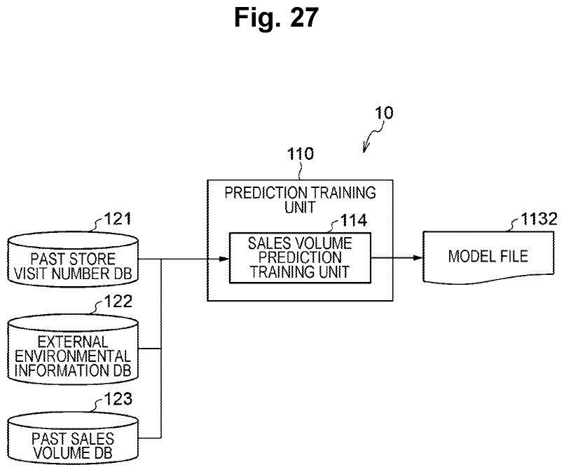

FIG. 27 is a block diagram illustrating an example of a functional configuration of the learning device 10. The learning device 10 according to the second embodiment is a device that trains a model for performing prediction in consideration of a sales state for each menu.

As illustrated in FIG. 27, the learning device 10 includes a prediction training unit 110 as a functional configuration. Each functional configuration is realized by the CPU 11 reading the training program stored in the ROM 12 or the storage 14, deploying the training program in the RAM 13, and executing the training program.

The prediction training unit 110 trains a model file 1132 for predicting the number of visits to a store such as a restaurant. Here, the product is a menu of dishes in the case of a restaurant. The prediction training unit 110 includes a sales volume prediction training unit 114.

The sales volume prediction training unit 114 performs machine learning using data recorded in the past store visit number DB 121, the external environmental information DB 122, and the past sales volume DB 123, and builds the model file 1132 for predicting the number of visits to a store. When training the model file 1132, the sales volume prediction training unit 114 builds the model file 1132 by using a model applicable to a regression problem such as multiple regression analysis.

For example, the sales volume prediction training unit 114 builds one prediction model for each category by collecting data of the same category, but may build a prediction model for each menu by collecting only data of the same menu. For example, building one prediction model for each category by collecting data of the same category means building a prediction model that predicts a sales rate of a category A by collecting data of the category A, and a menu belonging to the category A is a menu that can be changed daily, for example, the menu is a menu A on one day and the menu is a menu B on another day.

As illustrated in FIG. 3, the past store visit number DB 121 is a database that records a date and time, the number of visits to a store for each date and time. As illustrated in FIG. 4, the external environmental information DB 122 is a database that records a date and time and external environmental information for each date and time. Examples of the external environmental information include weather, a temperature, a rainfall amount, a wind direction, a wind speed, humidity, the number of people staying in a building, and a peripheral people flow. As illustrated in FIG. 18, the past sales volume DB 123 is a database that records a date and time, a category of products sold for each date and time, a menu name, a sales volume, a sold-out time, and the like.

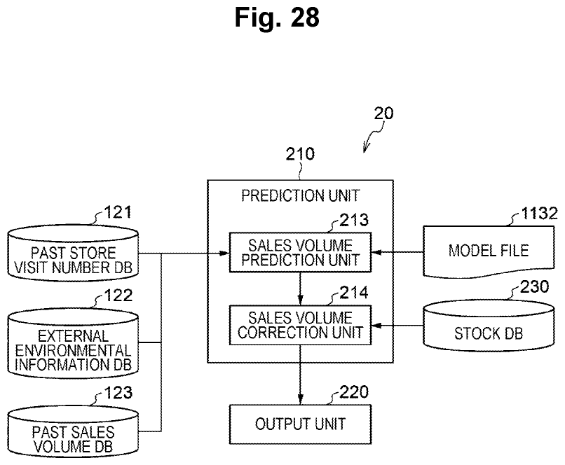

FIG. 28 is a block diagram illustrating an example of the functional configuration of the prediction device 20. The prediction device 20 according to the third embodiment is a device that performs prediction in consideration of the sales state for each menu.

As illustrated in FIG. 28, the prediction device 20 includes a prediction unit 210 and an output unit 220 as a functional configuration. Each functional configuration is realized by the CPU 21 reading the prediction program stored in the ROM 22 or the storage 24, deploying the prediction program in the RAM 23, and executing the training program.

The prediction unit 210 predicts a sales volume of each menu on the prediction target day by using the model file 1132 for predicting a sales rate of products sold at the store such as a restaurant. The prediction unit 210 includes a sales volume prediction unit 213 and a sales volume correction unit 214.

The sales volume prediction unit 213 calculates the predicted sales volume of each menu on the prediction target day by inputting data recorded in the past store visit number DB 121, the external environmental information DB 122, and the past sales volume DB 123 to the model file 1132 and by using an output from the model file 1132.

The sales volume correction unit 214 corrects the predicted sales volume of each menu on the prediction target day predicted by the sales volume prediction unit 213 by using the stock information of each menu recorded in a stock DB 230 illustrated in FIG. 10. The stock DB 230 is a database that records a date, a category, a menu name, stock data for an initial stock, and the like.

An example of the sales volume correction processing performed by the sales volume correction unit 214 will be described. First, the total distribution is set to zero. For Predicted sales volume>Initial stock for the menu, the sales volume correction unit 214 sets Predicted sales volume=Initial stock, and adds a quantity exceeding the initial stock to the total distribution. On the other hand, when Predicted sales volume≤Initial stock for the menu, the sales volume correction unit 214 calculates the distribution rate from the predicted sales rate of each menu such that the total becomes one. Furthermore, when Predicted sales volume≤Initial stock for the menu, the sales volume correction unit 214 corrects the predicted sales volume by setting Predicted sales volume=Predicted sales volume+Total distribution×Distribution rate for each menu.

Note that in a case where the initial stock cannot be acquired from the stock DB 230, the sales volume correction processing performed by the sales volume correction unit 214 may be skipped.

The output unit 220 presents the sales volume of each menu on the prediction target day predicted by the sales volume prediction unit 213 and corrected by the sales volume correction unit 214 to a user.

Next, actions of the learning device 10 will be described.

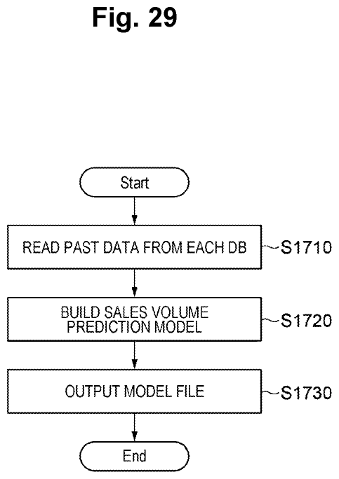

FIG. 29 is a flowchart illustrating an example of a flow of training processing performed by the learning device 10. The training processing is performed by the CPU 11 reading a training program from the ROM 12 or the storage 14, deploying the training program in the RAM 13, and executing the training program. FIG. 29 illustrates a flowchart when the model file 1132 for predicting a sales volume is built.

In step S1710, the CPU 11 acquires data recorded in the past store visit number DB 121, the external environmental information DB 122, and the past sales volume DB 123. An arbitrary period can be set as the acquisition target period.

Subsequent to step S1710, in step S1720, the CPU 11 performs machine learning using a model applicable to a regression problem such as multiple regression analysis with the sales rate of each menu on a daily basis as an objective variable and with the sales rate until the day before the prediction target day and the external environment such as temperature on the day as explanatory variables, and builds the model file 1132 for predicting a sales volume.

Subsequent to step S1720, in step S1730, the CPU 11 outputs the built model file 1132 as an external file.

Next, actions of the prediction device 20 will be described.

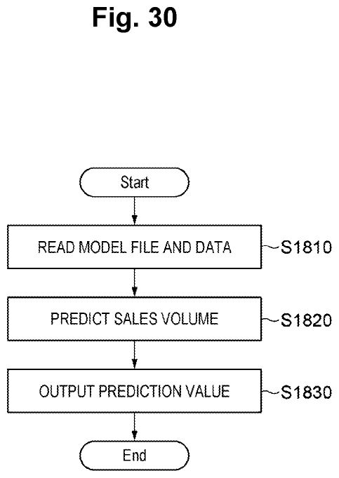

FIG. 30 is a flowchart illustrating an example of a flow of prediction processing performed by the prediction device 20. The prediction process is performed by the CPU 21 reading the prediction program from the ROM 22 or the storage 24, deploying the prediction program in the RAM 23, and executing the prediction processing. FIG. 30 illustrates a flowchart when the prediction device 20 predicts a sales volume on the prediction target day by using the model file 1132.

In step S1810, the CPU 21 acquires data recorded in the past store visit number DB 121, the external environmental information DB 122, and the past sales volume DB 123, and the model file 1132.

Subsequent to step S1810, in step S1820, the CPU 21 predicts a sales volume on the day of the prediction target day by inputting data recorded in the past store visit number DB 121, the external environmental information DB 122, and the past sales volume DB 123 to the model file 1132 and by using an output from the model file 1132.

Subsequent to step S1820, in step S1830, the CPU 21 outputs the predicted sales volume on the day of the prediction target day.

When outputting the sales volume on the day of the prediction target day, the CPU 21 executes a series of processing illustrated in FIG. 26 to predict the sales volume.

### Fourth Embodiment

The prediction device 20 may combine the processing of the first embodiment and the processing of the second embodiment. The combination of the first embodiment and the second embodiment is a combination of prediction performed in advance and prediction performed in real time on the day of the prediction target day according to the number of days until the prediction target day. In the prediction performed in advance, prediction is performed in consideration of a combination of menus, and in the prediction on the day, prediction is performed in consideration of the sales state on the day. Moreover, the prediction device 20 may correct the prediction values by using the initial stock amount in both the prediction performed in advance and the prediction performed in real time on the day of the prediction target day. By combining the processing of the first embodiment and the processing of the second embodiment, the prediction device 20 can improve the sales volume prediction accuracy even in a case where there is a daily changing menu.

Note that the training processing and the prediction processing executed by the CPUs reading software (programs) in each of the above-described embodiments may be executed by various processors other than the CPUs. Examples of the processor in this case include a programmable logic device (PLD) in which a circuit configuration can be changed after manufacturing a field-programmable gate array (FPGA) or the like, and a dedicated electric circuit that is a processor having a circuit configuration exclusively designed for executing specific processing such as an application specific integrated circuit (ASIC). Furthermore, the training processing and the prediction processing may be executed by one of these various processors, or may be executed by a combination of two or more processors of the same type or different types (for example, a plurality of FPGAs, a combination of a CPU and an FPGA, and the like). Furthermore, a hardware structure of these various processors is, more specifically, an electric circuit in which circuit elements such as semiconductor elements are combined.

Furthermore, in each of the above-described embodiments, an aspect has been described in which the training program is stored (installed) in advance in the storage 14 and the prediction program is stored (installed) in advance in the storage 24, but the disclosed technology is not limited thereto. The program may be provided in a form stored in a non-transitory storage medium such as a compact disk read only memory (CD-ROM), a digital versatile disk read only memory (DVD-ROM), or a universal serial bus (USB) memory. Furthermore, the program may be downloaded from an external device via a network.

With regard to the above-described embodiment, the following supplementary notes are further disclosed.

### (Supplement Note 1)

A prediction device including:
a memory, and
at least one processor that is connected to the memory,
in which the processor is configured to
acquire data regarding the number of past visits to a store, input the data to a trained store visit number prediction model, and predict the number of visits to a store on a prediction target day by using an output from the store visit number prediction model,
acquire data regarding the number of past visits to a store, a past sales volume, a menu feature, and a popular product to predict popularity of each product on the prediction target day, input the popularity to a trained sales rate prediction model, and predict a sales rate of each product by using an output from the sales rate prediction model, and
predict a sales volume of each product on the prediction target day by using the predicted number of visits to a store and the predicted sales rate of each product.

### (Supplement Note 2)

A non-transitory storage medium storing a program causing a computer to execute prediction processing,
the prediction processing including:
acquiring data regarding the number of past visits to a store, inputting the data to a trained store visit number prediction model, and predicting the number of visits to a store on a prediction target day by using an output from the store visit number prediction model;
acquiring data regarding the number of past visits to a store, a past sales volume, a menu feature, and a popular product to predict popularity of each product on the prediction target day, inputting the popularity to a trained sales rate prediction model, and predicting a sales rate of each product by using an output from the sales rate prediction model; and
predicting a sales volume of each product on the prediction target day by using the predicted number of visits to a store and the predicted sales rate of each product.

### (Supplement Note 3)

A learning device including:
a memory, and
at least one processor that is connected to the memory,
in which the processor is configured to
train a store visit number prediction model that receives, as an input, data regarding the number of past visits to a store and outputs the number of visits to a store on a prediction target day, and
train a sales rate prediction model that receives, as an input, the number of past visits to a store, a past sales volume, and past popularity for each product given using the number of past visits to a store, the external environmental information, and the menu feature, and outputs a sales rate of each product.

### (Supplement Note 4)

A non-transitory storage medium storing a program causing a computer to execute training processing,
the training processing including:
training a store visit number prediction model that receives, as an input, data regarding the number of past visits to a store and outputs the number of visits to a store on a prediction target day, and
training a sales rate prediction model that receives, as an input, the number of past visits to a store, a past sales volume, and past popularity for each product given using the number of past visits to a store, the external environmental information, and the menu feature, and outputs a sales rate of each product.

### REFERENCE SIGNS LIST

10 Learning device
110 Predict training unit
111 Store visit number prediction training unit
112 Rate prediction training unit
113 Sales time feature training unit
114 Sales volume prediction training unit
131 Model file
132 Model file
1131 Model file
20 Prediction device
210 Prediction unit
211 Store visit number prediction unit
212 Rate prediction unit
213 Sales volume prediction unit
214 Sales volume correction unit
220 Output unit

1. A prediction device comprising:
a memory; and
at least one processor connected to the memory, wherein the processor is configured to:
acquire data regarding the number of past visits to a store, inputs the data to a trained store visit number prediction model, and predicts the number of visits to a store on a prediction target day by using an output from the store visit number prediction model,
acquire data regarding the number of past visits to a store, a past sales volume, a menu feature, and a popular product to predict popularity of each product on the prediction target day, inputs the popularity to a trained sales rate prediction model, and predicts a sales rate of each product by using an output from the sales rate prediction model, and
predict a sales volume of each product on the prediction target day by using the predicted number of visits to a store and the predicted sales rate of each product.

2. The prediction device according to claim 1, wherein the processor is further configured to use similarity among product names of the products to group the products and predict the sales rate of each product.

3. The prediction device according to claim 1, the processor is further configured to correct the predicted sales volume of each product by using stock data of each product.

4. The prediction device according to claim 1, wherein the processor is further configured to acquire data regarding the number of past visits to a store, the past sales volume until a designated time of the prediction target day, and a sales time feature of the prediction target day, and to predict the sales rate of each product.

5. A learning device comprising:
a memory; and
at least one processor connected to the memory,
wherein the processor is configured to:
train a store visit number prediction model that receives, as an input, data regarding the number of past visits to a store and outputs the number of visits to a store on a prediction target day, and
train a sales rate prediction model that receives, as an input, the number of past visits to a store, a past sales volume, and past popularity for each product given using the number of past visits to a store, the past sales volume, and a menu feature, and outputs a sales rate of each product.

6. A prediction method comprising:
by a processor,
acquiring data regarding the number of past visits to a store, inputting the data to a trained store visit number prediction model, and predicting the number of visits to a store on a prediction target day by using an output from the store visit number prediction model;
acquiring data regarding the number of past visits to a store, a past sales volume, a menu feature, and a popular product to predict popularity of each product on the prediction target day, inputting the popularity to a trained sales rate prediction model, and predicting a sales rate of each product by using an output from the sales rate prediction model; and
predicting a sales volume of each product on the prediction target day by using the predicted number of visits to a store and the predicted sales rate of each product.

7-8. (canceled)
